(19) United States
(12) Patent Application Publication
(10) Pub. No.: US 2006/0067367 A1
(43) Pub. Date: Mar. 30, 2006

(54) Method for selecting timing master in synchronous ethernet system

(75) Inventors: Jae-Hun Cho, Seoul (KR); Jun-Ho Koh, Suwon-si (KR); Jong-Kwon Kim, Gunpo-si (KR); Yun-Je Oh, Yongin-si (KR); Jong-Ho Yoon, Goyang-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/223,266

(22) Filed: Sep. 9, 2005

(30) Foreign Application Priority Data
Sep. 25, 2004 (KR) 2004-77607

(51) Int. Cl. H04L 12/56; H04J 3/06; H04L 12/28

(52) U.S. Cl. 370/503; 370/389

(57) ABSTRACT

Disclosed is a method for establishing a synchronization in a synchronous Ethernet system. Devices are classified according to the type of the devices, and a device having a highest class in the synchronous Ethernet system is detected, then it is determined if the device having the highest class is able to serve as the timing master. If so, the device having the highest class is able to serve as the timing master if only one such device is detected; otherwise, the timing master between devices having the highest class is selected through a collision algorithm.

### CLAIM OF PRIORITY

This application claims the benefit under 35 U.S.C. 119 of an earlier application entitled “Method For Selecting Timing Master In Synchronous Ethernet System,” filed with the Korean Intellectual Property Office on Sep. 25, 2004 and assigned Serial No. 2004-77607, the contents of which are incorporated herein by reference.

### BACKGROUND OF THE INVENTION

1. Field of the Invention

The present invention relates to a synchronous Ethernet system. More particularly, the present invention relates to a method for establishing a synchronization in a synchronous Ethernet system.

2. Description of the Related Art

An Ethernet system was originally developed by Xerox Co. in conjunction with Intel and DEC, and it has recently been standardized by Institute of Electrical and Electronics Engineers (IEEE) 802.3 The Ethernet LAN uses a coaxial cable or an unshielded twisted pair (UTP) cable having a special grade. The Ethernet system is generally known as “Ethernet 10BASE-T”, which provides a transmission rate of about 10 Mbps, and is accessed using a Carrier Sense Multiple Access/Collision Detect (CSMA/CD) protocol defined in IEEE 802.3. Fast Ethernet or Ethernet 100BASE-T may provide a transmission rate of about 100 Mbps and is used as a backbone of the LAN supporting the workstations equipped with 10BASE-T cards. Gigabit Ethernet may provide a high transmission rate of about 1000 Mbps.

Since the conventional Ethernets competitively make an access using the CSMA/CD protocol defined in IEEE 802.3, an upper class service frame is first transmitted as an Ethernet frame while maintaining the Inter Frame Gap (IFG). The frames may be transmitted according to a priority thereof regardless of the type of the upper service frames.

The Ethernet system transmits data through a competitive access scheme if there are packets having the same priority. As such, the Ethernet system is not adaptable for transmitting multimedia data, which are sensitive to a transmission delay. However, such a problem has recently been solved by means of a synchronous Ethernet system, which has the same compatibility as the conventional Ethernet system but allocates a priority to the multimedia data, such as video/voice data, in such a manner that the multimedia data can be transmitted first.

The synchronous Ethernet system transmits data in a cycle unit, in which one cycle includes a Sync field for transmitting the multimedia data and an Async field for transmitting Ethernet data. In order to transmit synchronous multimedia data, it is necessary to establish a synchronization of a total system. That is, it is necessary to select the timing master of the system.

FIG. 1 is a view illustrating a transmission cycle of a synchronous Ethernet system.

As shown, the current synchronous Ethernet system transmits data with a transmission cycle of 125 μsec, in which each transmission cycle includes a Sync field 102-1 or 102-2 for transmitting synchronous data, an Async field 103-1 or 103-2 for transmitting asynchronous data, and a frame control signal 101-1 or 101-2 for establishing a synchronization of the system. The Sync field 102-1 or 102-2 has the highest priority in the transmission cycle. The Sync field 102-1 or 102-2 includes 10 sub-synchronous frames, each of which consists of 738 bytes, as a default value. The Async field 103-1 or 103-2 is the remaining part of the transmission cycle except for the Sync field 102-1 or 102-2, in which variable asynchronous data are included in the Async field 103-1 or 103-2 as frame units. The synchronization of the system can be attained by means of the frame control signal 101-1 or 101-2. To this end, it is necessary for the synchronous Ethernet system to establish the timing master capable of generating the frame control signals.

FIG. 2 is a flowchart illustrating the conventional process of establishing the timing master in the synchronous Ethernet system.

Referring to FIG. 2, ports of devices provided in the system are first analyzed in order to establish the timing master (step 201). It is then determined if there is a device exclusively having an input port based on the analysis result (step 202). If so, the device exclusively having the input port is selected as a timing master (step 203). Otherwise, it is determined if there is a device having the input port, that is, a device having the input and output ports (step 204).

Thereafter, it is determined if there are at least two devices having the input port in the system (step 205). If so, it is further determined if there is a device having no connection at the output port thereof (step 206), and if so, the device is selected as the timing master (step 207).

Meanwhile, if the number of devices having the input port in the system is less than two in step 205, the device having the input port is selected as the timing master (step 208).

If it is determined in step 204 that there is no device having the input port, that is, if the devices exclusively have the output port in the system, the timing master cannot be established.

FIGS. 3a to 3c are schematic views illustrating the conventional method of establishing the timing master.

FIG. 3a illustrates a system including a first device 31 exclusively having an output port and a second device 32 exclusively having an input port connected to the first device 31. In this case, the second device 32 is selected as the timing master.

FIG. 3b illustrates a system including a first device 31 exclusively having an output port and second and third devices 33 and 34 having both input and output ports connected to the first device 31. In this case, the second and third devices 33 and 34 can be selected as the timing master. Preferably, the third device 34, which has no connection at the output port thereof, is selected as the timing master.

FIG. 3c illustrates a system including a first device 31 exclusively having an output port, a second device 35 having both input and output ports, and a third device 36 exclusively having an input port connected to the first and second devices 31 and 35. In this case, the third device 36 provided with the input port having the highest priority is selected as the timing master.

If the timing master is selected according to the above schemes, it is necessary to analyze all ports of the devices in the system, and the priority of the devices may vary according to the state (connection) of ports of the devices. In addition, if a plurality of devices having the same port structure are provided, it is difficult to select the timing master.

According to another conventional method of selecting the timing master, when a new device is provided in the existing system, the timing master is selected between the existing system and the new device.

FIG. 4 is a timing view for illustrating the procedure of selecting the timing master when the new device is connected to the conventional synchronous Ethernet system.

Referring to FIG. 4, when a new device 42 is connected to an Ethernet system 41, if there is a physical connection (401) between the Ethernet system 41 and the new device 42, Sync bits of the new device and the Ethernet system are mutually detected (402) in order to select the timing master.

That is, the timing master is selected (403) according to the Sync bits.

The Sync bit is included in each synchronous frame of the synchronous Ethernet system, so that the synchronous Ethernet system 41 and the new device 42 can be certificated through the detection of the Sync bit. In particular, in order to select the timing master, the Sync bits of the synchronous Ethernet system 41 and the new device 42 are mutually detected. If the Ethernet system 41 has the Sync bit even though the new device 42 has no Sync bit, the timing master of the Ethernet system 41 is selected as the timing master for the whole system. In contrast, if the new device 42 has the Sync bit although the Ethernet system 41 has no Sync bit, the new device 42 is selected as the timing master for the whole system.

Meanwhile, if the synchronous Ethernet system 41 and the new device 42 have no Sync bit, the timing master of the Ethernet system 41 is selected as the timing master for the whole system after waiting for a predetermined period of time (for example, 100 cycles). In addition, if the synchronous Ethernet system 41 and the new device 42 have the Sync bit, the MAC address of the Ethernet system 41 is compared with that of the new device 42. If the MAC address of the Ethernet system 41 has a higher value than that the new device 42, the timing master of the Ethernet system 41 is selected as the timing master for the whole system. Otherwise, the new device 42 is selected as the timing master for the whole system.

As described above, according to the conventional method, the Sync bits must be detected whenever the new device is connected to the Ethernet system. Moreover, it is necessary to wait for a predetermined period of time if the Ethernet system and the new device have no Sync bits.

### SUMMARY OF THE INVENTION

Accordingly, the present invention has been made to solve the above-mentioned problems occurring in the prior art and provides additional advantages, by providing a method for stably and simply selecting a timing master from among devices provided in a synchronous Ethernet system by classifying the devices according to the type of the devices and comparing the class of the devices with each other.

In one embodiment, there is provided a method of selecting a timing master in a synchronous Ethernet system which includes the steps of: allocating classes to devices provided in the synchronous Ethernet system; detecting a device having a highest class among the devices provided in the synchronous Ethernet system and determining if the device having the highest class is able to serve as the timing master; determining if a number of the device having the highest class is one when it is determined that the device having the highest class is able to serve as the timing master; determining the device having the highest class as the timing master of the synchronous Ethernet system if only one device having the highest class is detected; and selecting the timing master of the synchronous Ethernet system from among devices having the highest class through a collision algorithm if there are at least two devices having the highest class.

### BRIEF DESCRIPTION OF THE DRAWINGS

The above features and advantages of the present invention will be more apparent from the following detailed description taken in conjunction with the accompanying drawings, in which:

FIG. 1 is a schematic view illustrating a transmission cycle of a conventional synchronous Ethernet system;

FIG. 2 is a flowchart illustrating the conventional method of selecting the timing master;

FIGS. 3a to 3c are schematic views illustrating another conventional method of selecting the timing master;

FIG. 4 is a timing view illustrating the procedure for selecting the timing master when the new device is connected to the conventional synchronous Ethernet system;

FIG. 5 is a flowchart illustrating the procedure for selecting the timing master in the synchronous Ethernet system by classifying devices based on the type thereof according to one embodiment of the present invention;

FIGS. 6a to 6d are schematic views illustrating systems including devices used for selecting the timing master according to one embodiment of the present invention; and

FIG. 7 is a timing view illustrating the procedure for selecting the timing master when the new device is connected to the synchronous Ethernet system according to one embodiment of the present invention.

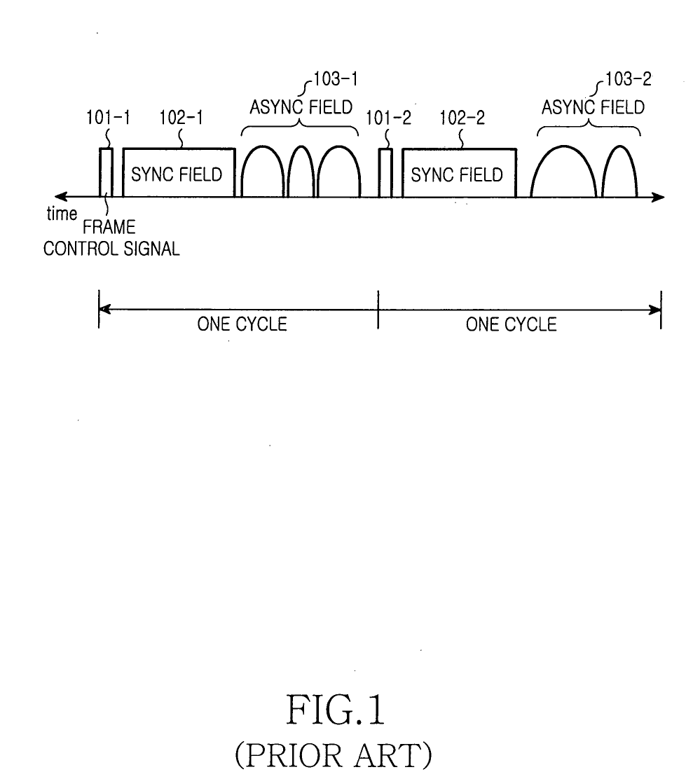

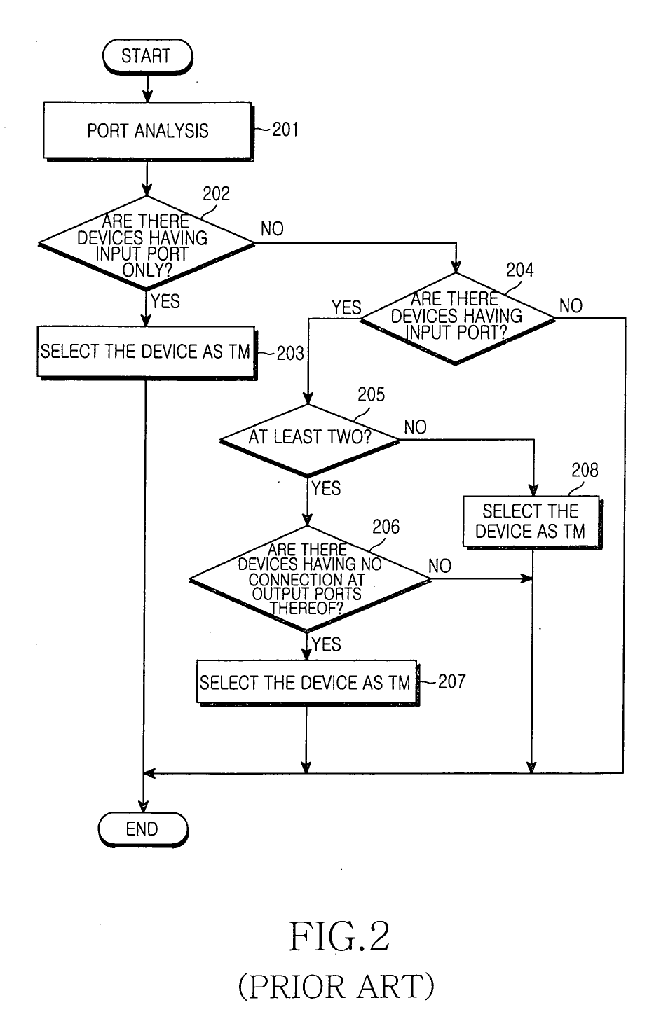

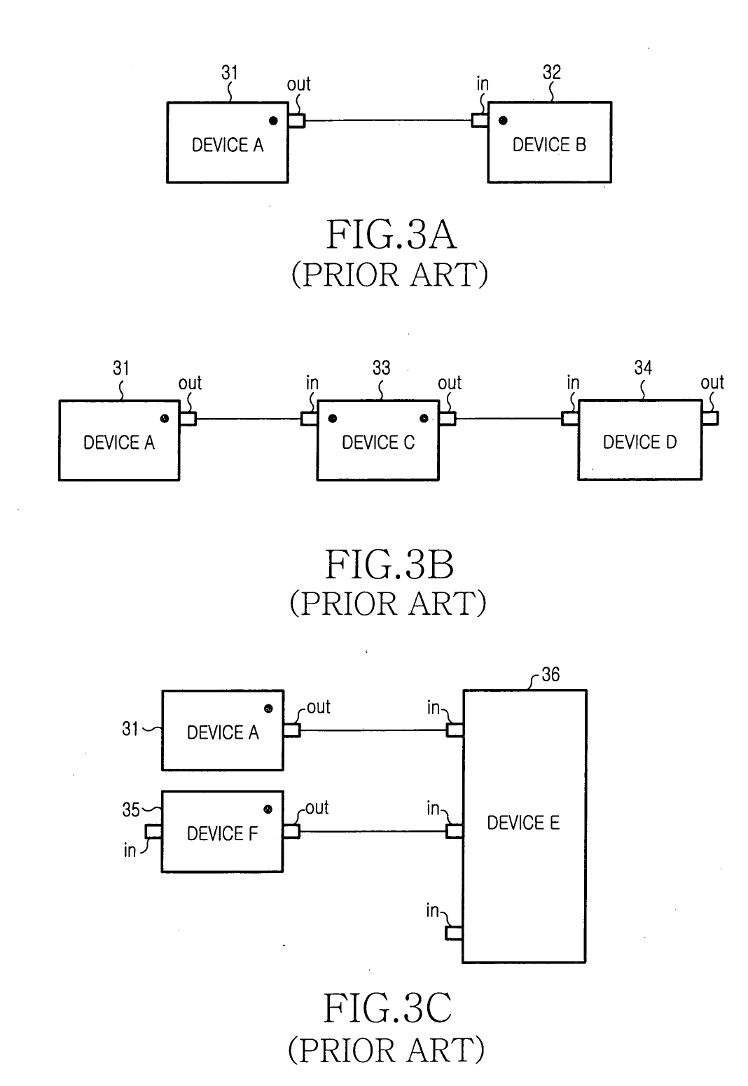

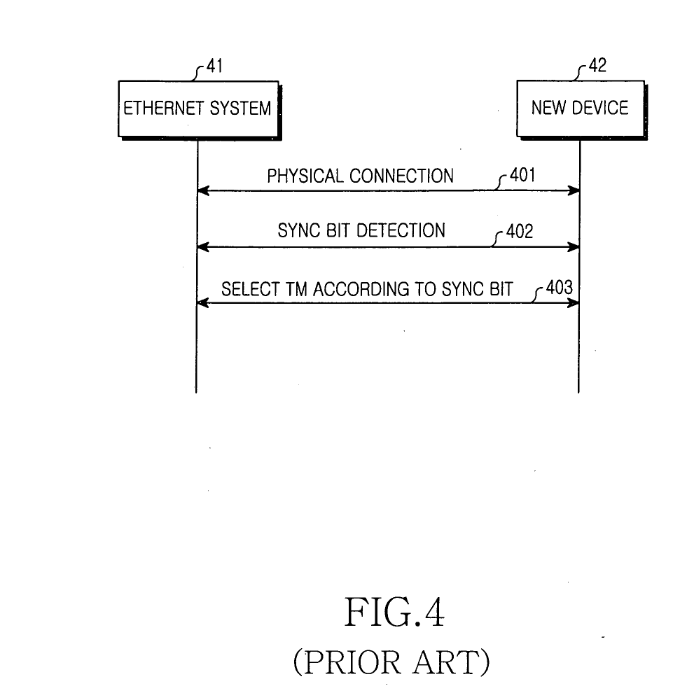

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

The present invention provides a method for selecting a timing master from among devices provided in a synchronous Ethernet system by classifying the devices and comparing the class of the devices with each other, and then applying the timing master to each topology.

The classes of the devices are shown in Table 1.

TABLE 1

| Class | Device |
|---|---|
| Class 0 | Legacy Ethernet device |
| Class 1 | Data terminal supporting synchronous Ethernet |
| Class 1+ | Class 1 with timing master function |
| Class 2 | Switch device supporting synchronous Ethernet |

The above classification can be further sub-divided depending on systems according to the present invention. If the devices are classified as shown in Table 1, the timing master can be effectively and rapidly selected even if the size of class information becomes enlarged. Thus, the system administrator can manage the system by properly selecting the class in a unique way for the devices. For example, among devices belonging to the class 1+, devices performing special functions can be further classified as a class 1++ such that the priority can be first allocated to the devices belonging to the class 1++.

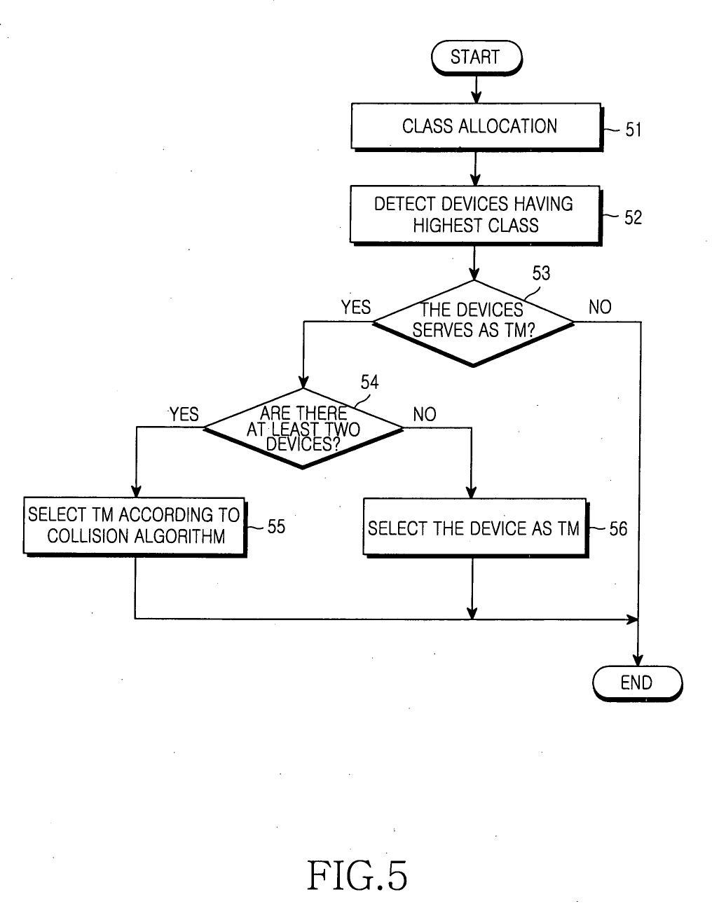

Hereinafter, the method for selecting the timing master according to the class of the devices in the synchronous Ethernet system will be described in detail with reference to FIG. 5.

FIG. 5 is a flowchart illustrating the process of selecting the timing master in the synchronous Ethernet system by classifying devices according to one embodiment of the present invention.

Referring to FIG. 5, the class for selecting the timing master is assigned to the devices provided in the synchronous Ethernet system (step 51). For instance, the classes as shown in Table 1 are allocated to the devices, respectively. The class is allocated to the device when the system is established. The information relating to a class can be included in the device information of each device in such a manner that class information of the devices can be interchanged when the system is established.

The class information interchange may occur when initializing or modifying the system. According to the present invention, a message for transferring the class information is created in an MAC class or an upper application class of each device, and the message is broadcasted to the devices of the system in order to attain the class information.

After that, devices having the highest class are detected from among devices in the system (step 52).

It is then determined if the devices having the highest class can serve as the timing master for the system (step 53). If the devices having the highest class cannot serve as the timing master, the process may end without selecting the timing master.

If the devices having the highest class can serve as the timing master, it is determined if there are at least two devices having the highest class (step 54). If there are at least two devices having the highest class, a device selected according to a collision algorithm serves as the timing master (step 55). However, if the number of the devices having the highest class is less than two, the detected device having the highest class is selected as the timing master (step 56).

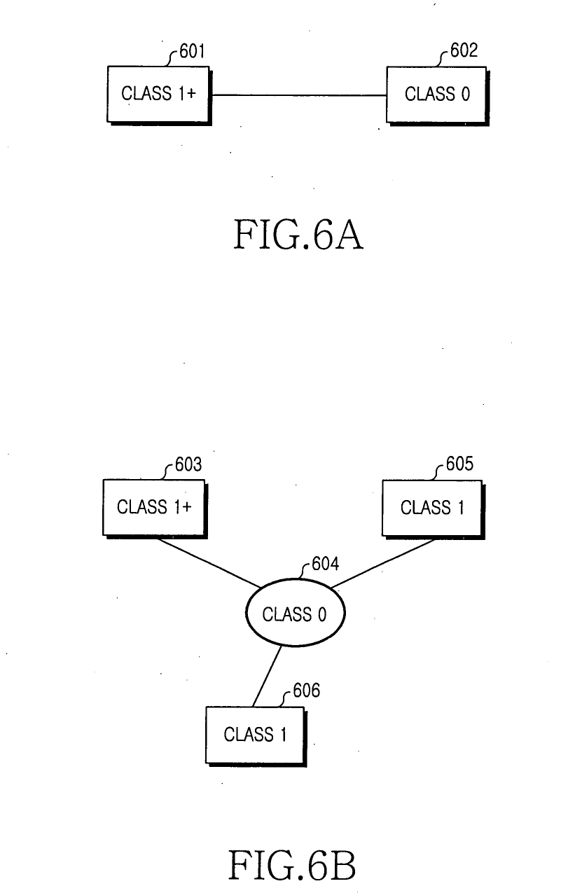

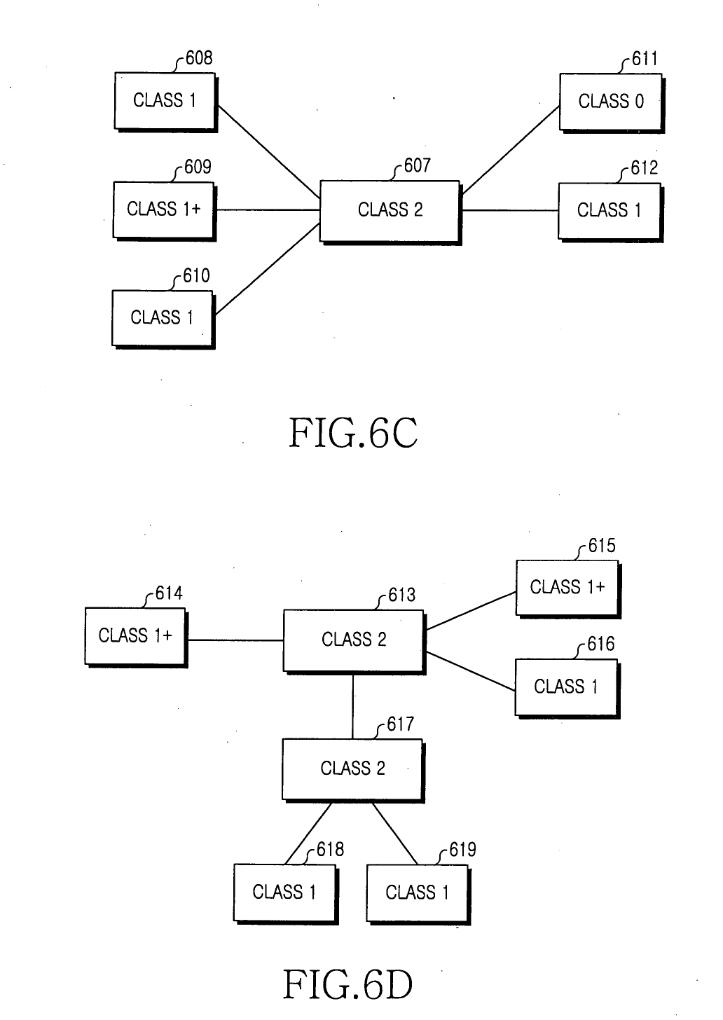

FIGS. 6a to 6d are schematic views illustrating systems including devices used for selecting the timing master according to one embodiment of the present invention. In particular, FIGS. 6a to 6d show the classes allocated to the devices according to Table 1. That is, in accordance with Table 1, a legacy Ethernet device is defined as a class 0 and data terminal equipment (DTE) supporting the synchronous Ethernet is defined as a class 1. In addition, among devices belonging to the class 1, devices to be served as the timing master are defined as a class 1+, and a switching device to be served as the timing master is defined as a class 2.

FIG. 6a shows a system including a first device 601 having the class 1+ and a second device 602 having the class 0 and directly connected to the first device 601. In this case, a device having the highest class priority (for instance, the first device 601) is detected according to the flowchart as shown in FIG. 5. In addition, it is determined if the first device having the highest class can serve as the timing master. According to FIG. 6a, the first device has the class 1+, so the first device can serve as the timing master. In addition, it is determined if there are at least two first devices having the highest class. Since the first device having the highest class is only one, the first device 601 having the class 1+ is selected as the timing master of the system.

FIG. 6b shows a system having a start topology which includes a first device 603 having the class 1+, second devices 605 and 606 having the class 1, and a third device 604 having the class 0 and connected the first and second devices 603, 605 and 606. The third device 604 serves as a hub for connecting various devices thereto. In this case, a device having the highest class priority (for instance, the first device 603) is detected according to the flowchart as shown in FIG. 5. In addition, it is determined if the first device having the highest class can serve as the timing master. According to FIG. 6b, the first device has the class 1+, so the first device can serve as the timing master. Further, it is determined if there are at least two first devices having the highest class. Since the first device having the highest class is only one, the first device 603 having the class 1+ is selected as the timing master of the system.

FIG. 6c shows a system having a start topology which includes a first device 609 having the class 1+, second devices 608, 610 and 612 having the class 1, a third device 611 having the class 0, and a fourth device 607 having the class 2 and connected the first to third devices. The fourth device 607 serves as a switching device for connecting various devices thereto. In this case, a device having the highest class priority (for instance, the fourth device 607) is detected according to the flowchart as shown in FIG. 5. In addition, it is determined if the fourth device having the highest class can serve as the timing master. According to FIG. 6c, the fourth device has the class 2, so the fourth device can serve as the timing master. Then, it is determined if there are at least two fourth devices having the highest class. Since the fourth device having the highest class is only one, the fourth device 607 having the class 2 is selected as the timing master of the system.

FIG. 6d shows a system including first devices 614 and 615 having the class 1+, second devices 613 and 617 having the class 2, and third devices 616, 618 and 619 having the class 1, wherein the first devices 614 and 615 and the third device 616 are connected to the second device 613, and the third devices 618 and 619 and the second device 613 are connected to the second device 617. In this case, devices having the highest class priority (for instance, the second devices 613 and 617) are detected according to the flowchart as shown in FIG. 5. Thereafter, it is determined if the second devices having the highest class can serve as the timing master. According to FIG. 6d, the second devices have the class 2, so the second devices can serve as the timing master. Then, it is determined if there are at least two second devices having the highest class. Since the number of the second devices having the highest class is two, one of the second devices having the class 2 is selected as the timing master of the system through the collision algorithm between the second devices.

The collision algorithm is used for determining the priority between devices having the same construction and can be variously embodied. In general, the collision algorithm compares the MAC addresses of the devices with each other in order to determine the priority of the devices according to the size of the MAC address.

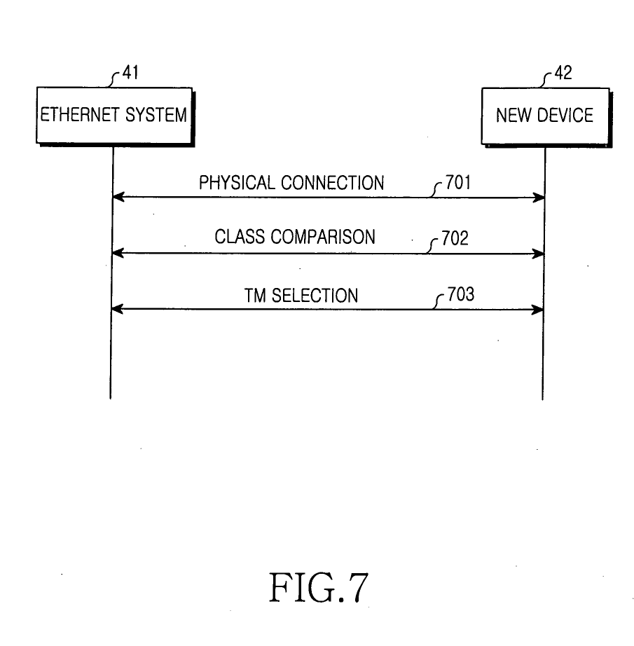

Hereinafter, a method for selecting the timing master when a new device is connected to the Ethernet system according to the present invention will be described with reference to FIG. 7.

FIG. 7 is a timing view illustrating the process of selecting the timing master when a new device is connected to the synchronous Ethernet system according to one embodiment of the present invention.

Referring to FIG. 7, when the new device 42 is connected to the synchronous Ethernet system 41, if there is a physical connection (701) between the Ethernet system 41 and the new device 42, class information of the Ethernet system 41 and the new device 42 is mutually compared (702) in order to select the timing master.

That is, the timing master is selected (703) according to the class information of the new device and the Ethernet system.

Therefore, if the new device is connected to the Ethernet system, the timing master is selected by simply comparing the class information of the new device with that of the Ethernet system, instead of detecting the Sync bit.

In detail, in order to select the timing master, the class information of the Ethernet system 41 and the new device 42, that is, the class information of the whole Ethernet system including the new device 42 is mutually compared. At this time, if the device having the highest class can serve as the timing master, the device is selected as the timing master. If there are several devices having the same highest class, the timing master is selected according to the collision algorithm.

According to the present invention, the timing master can be selected through two schemes. First, the timing master is selected by comparing the classes of the new device 42 and the Ethernet system 41 with the class of the present timing master. Second, the timing master is selected by comparing the class of the new device 42 with the classes of devices provided in the Ethernet system 41.

As described above, according to the present invention, the devices are classified according to the type of the devices and the timing master is selected based on the order of classification of the devices. Thus, the timing master can be stably and simply selected in the synchronous Ethernet system. In addition, the method of the present invention can be embodied as a program so that the method can be stored in recoding media, such as CD ROMs, RAMs, floppy discs, hard discs or optical magnetic discs.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for selecting a timing master in a synchronous Ethernet system, the method comprising the steps of:
assigning classes to a plurality of devices provided in the synchronous Ethernet system;
detecting a device having a highest class and determining if the device having the highest class is able to serve as the timing master;
determining if a number of the device having the highest class is one when it is determined that the device having the highest class is able to serve as the timing master;
determining the device having the highest class as the timing master of the synchronous Ethernet system if only one device having the highest class is detected; and
selecting the timing master of the synchronous Ethernet system from among devices having the highest class through a collision algorithm if there are at least two devices having the highest class.

2. The method as claimed in claim 1, wherein the classes for the devices include a class 0 for a legacy Ethernet device, a class 1 for data terminal equipment supporting the synchronous Ethernet system, a class 1+ for devices to be served as the timing master from among the devices belonging to the class 1, and a class 2 for a switching device to be served as the timing master.

3. The method as claimed in claim 1, wherein the collision algorithm compares MAC addresses of the devices having a same priority with each other in order to determine the priority of the devices according to the size of the MAC address.

4. The method as claimed in claim 1, wherein the class is previously allocated to each device by interchanging class information of the device when the synchronous Ethernet system is established.

5. The method as claimed in claim 1, wherein the class is previously assigned to each device by creating data representing class information of the device in an MAC class of the device and broadcasting the data to the device.

6. The method as claimed in claim 1, wherein the class is previously assigned to each device by creating data representing class information of the device in an application class of the device and broadcasting the data to the devices.
